(19) United States
(12) Patent Application Publication
(10) Pub. No.: US 2025/0097114 A1
(43) Pub. Date: Mar. 20, 2025

(54) APPARATUS, METHOD AND COMPUTER PROGRAM

(71) Applicant: NOKIA TECHNOLOGIES OY, Espoo (FI)

(72) Inventors: Srinivas GARIKIPATI, Bangalore (IN); Mohamed Amin NASSAR, Munich (DE); Horst Thomas BELLING, Erding (DE); Apostolos PAPAGEORGIOU, Nice (FR); Pallab GUPTA, Bangalore (IN)

(21) Appl. No.: 18/884,362

(22) Filed: Sep. 13, 2024

(30) Foreign Application Priority Data
Sep. 14, 2023 (IN) 202341061979

(51) Int. Cl. H04L 41/0894

(52) U.S. Cl. CPC H04L 41/0894

(57) ABSTRACT

There is provided an apparatus comprising: means for storing at least one flag in a first state at a first time, wherein the at least one flag is associated with at least one user equipment and the first state indicates that no policy association is required for the at least one user equipment; means for receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and means for, in response to receiving the request, updating the flag to the second state.

### CROSS-REFERENCE TO RELATED APPLICATIONS

This application claims priority to Indian Application No. 202341061979, filed Sep. 14, 2023, the entire contents of which are incorporated herein by reference.

### TECHNICAL FIELD

Various example embodiments of this disclosure relate to a method, apparatus, and computer program and in particular but not exclusively to policy associations in a communications network.

### BACKGROUND

A communication system can be seen as a facility that enables communication sessions between two or more entities such as user terminals, base stations and/or other nodes by providing carriers between the various entities involved in the communications path. A communication system can be provided, for example, by means of a communication network and one or more compatible communication devices. The communication sessions may comprise, for example, communication of data for carrying communications, such as voice, video, electronic mail (email), text message, multimedia and/or content data and so on. Non-limiting examples of services provided comprise two-way or multi-way calls, data communication or multimedia services and access to a data network system, such as the Internet. In a wireless communication system, at least a part of a communication session between at least two stations occurs over a wireless link. Examples of wireless communication systems comprise public land mobile networks (PLMN), satellite based communication systems and different wireless local networks, for example wireless local area networks (WLAN). Some wireless communication systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

Some example embodiments of this disclosure will be described with respect to certain aspects. These aspects are not intended to indicate key or essential features of the example embodiments of this disclosure, nor are they intended to be used to limit the scope thereof. Other features, aspects, and elements will be readily apparent to a person skilled in the art in view of this disclosure.

According to a first aspect, there is provided an apparatus comprising: means for storing at least one flag in a first state at a first time, wherein the at least one flag is associated with at least one user equipment and the first state indicates that no policy association is required for the at least one user equipment; means for receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and means for, in response to receiving the request, updating the flag to the second state.

According to some examples, the apparatus comprises means for storing a transaction identifier which is specific to the request.

According to some examples, the apparatus comprises means for receiving multiple requests and multiple corresponding transaction identifiers.

According to some examples, the apparatus comprises means for starting a timer in response to updating the flag to the second state, and means for reverting the flag to the first state upon expiry of the timer.

According to some examples, the apparatus comprises means for causing one or more other entities to update the flag to the second state, the one or more other entities comprising at least one of the following: a Unified Data Repository; or an Access and Mobility Management Function.

According to some examples, the policy association comprises at least one of the following: a user equipment behaviour policy; an access management policy; or a session management policy.

According to some examples, the service which has been or will be provisioned at the at least one user equipment is provisioned by an application function.

According to some examples, the at least one flag comprises a first flag, and the apparatus comprises means for storing a second flag, wherein the second flag is configured to be updated between the first state and the second state in response to an instruction from an operation and maintenance node.

According to some examples, the apparatus comprises means for exposing both the first and second flags to a service consumer; or exposing only one of the first or second flags to a service consumer.

According to some examples, the apparatus comprises a unified data management node.

According to some examples, the means comprises at least one processor; and at least one memory storing instructions that, when executed by the at least one processor, cause the performance of the apparatus.

According to a second aspect, there is provided an apparatus comprising: at least one processor; and at least one memory storing instructions that, when executed by the at least one processor, cause the apparatus at least to perform: storing at least one flag in a first state at a first time, wherein the at least one flag is associated with at least one user equipment and the first state indicates that no policy association is required for the at least one user equipment; receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and, in response to receiving the request, updating the flag to the second state.

According to a third aspect, there is provided an apparatus comprising: circuitry for storing at least one flag in a first state at a first time, wherein the at least one flag is associated with at least one user equipment and the first state indicates that no policy association is required for the at least one user equipment; circuitry for receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and circuitry for, in response to receiving the request, updating the flag to the second state.

According to a fourth aspect, there is provided a method performed by an apparatus, the method comprising: storing, at the apparatus, at least one flag in a first state at a first time, wherein the at least one flag is associated with at least one user equipment and the first state indicates that no policy association is required for the at least one user equipment; receiving, at the apparatus, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and in response to receiving the request, updating the flag to the second state.

According to some examples, the method comprises storing a transaction identifier which is specific to the request.

According to some examples, the method comprises receiving multiple requests and multiple corresponding transaction identifiers.

According to some examples, the method comprises starting a timer in response to updating the flag to the second state, and reverting the flag to the first state upon expiry of the timer.

According to some examples, the method comprises causing one or more other entities to update the flag to the second state, the one or more other entities comprising at least one of the following: a Unified Data Repository; or an Access and Mobility Management Function.

According to some examples, the policy association comprises at least one of the following: a user equipment behaviour policy; an access management policy; or a session management policy.

According to some examples, the service which has been or will be provisioned at the at least one user equipment is provisioned by an application function.

According to some examples, the at least one flag comprises a first flag, and the method comprises storing a second flag, wherein the second flag is configured to be updated between the first state and the second state in response to an instruction from an operation and maintenance node.

According to some examples, the method comprises exposing both the first and second flags to a service consumer; or exposing only one of the first or second flags to a service consumer.

According to some examples, the apparatus comprises a unified data management node.

According to a fifth aspect, there is provided a computer program comprising instructions which, when executed by an apparatus, cause the apparatus to perform at least the following: storing, at the apparatus, at least one flag in a first state at a first time, wherein the at least one flag is associated with at least one user equipment and the first state indicates that no policy association is required for the at least one user equipment; receiving, at the apparatus, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and in response to receiving the request, updating the flag to the second state.

According to a sixth aspect, there is provided a computer program comprising instructions stored thereon for performing at least the following: storing at least one flag in a first state at a first time, wherein the at least one flag is associated with at least one user equipment and the first state indicates that no policy association is required for the at least one user equipment; receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and in response to receiving the request, updating the flag to the second state.

According to a seventh aspect, there is provided a non-transitory computer readable medium comprising program instructions that, when executed by an apparatus, cause the apparatus to perform at least the following: storing, at the apparatus, at least one flag in a first state at a first time, wherein the at least one flag is associated with at least one user equipment and the first state indicates that no policy association is required for the at least one user equipment; receiving, at the apparatus, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and in response to receiving the request, updating the flag to the second state.

According to an eighth aspect, there is provided a non-transitory computer readable medium comprising program instructions stored thereon for performing at least the following: storing at least one flag in a first state at a first time, wherein the at least one flag is associated with at least one user equipment and the first state indicates that no policy association is required for the at least one user equipment; receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and in response to receiving the request, updating the flag to the second state.

According to a ninth aspect, there is provided an apparatus comprising: means for sending, at a first time, a first policy control set-up request for setting up a policy association for at least one user equipment, a purpose of the policy association being to satisfy service requirements of a service which has been or will be provisioned at the at least one user equipment; means for, in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and means for sending, at a second time which is after the first time, a second policy control set-up request for the at least one user equipment.

According to some examples, the apparatus comprises means for receiving, in response to the second policy control set-up request, an identifier of a policy and charging function.

According to some examples, the apparatus comprises means for contacting the policy and charging function to create the at least one policy association for the at least one user equipment, the at least one policy association comprising at least one of the following: a user equipment behaviour policy; an access management policy; or a session management policy.

According to some examples, the apparatus comprises means for waiting for a configured time period after sending the first policy control set-up request before sending the second policy discovery request.

According to some examples, the apparatus comprises means for sending a subscription request in response to receiving the error response, and waiting for a notification before sending the second policy control set-up request.

According to some examples, the apparatus comprises means for sending an error message when it is determined that no suitable policy and charging function is assigned for the at least one user equipment and the at least one user equipment is not registered with a unified data management node.

According to some examples, the first and second policy discovery requests are sent to a binding support function which acts as an intermediary between the apparatus and a unified data management node.

According to some examples, the apparatus comprises a network exposure function node.

According to some examples, the means comprises at least one processor; and at least one memory storing instructions that, when executed by the at least one processor, cause the performance of the apparatus.

According to a tenth aspect, there is provided an apparatus comprising: at least one processor; and at least one memory storing instructions that, when executed by the at least one processor, cause the apparatus at least to perform: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to an eleventh aspect, there is provided an apparatus comprising: circuitry for sending, at a first time, a first policy control set-up request for setting up a policy association for at least one user equipment, a purpose of the policy association being to satisfy service requirements of a service which has been or will be provisioned at the at least one user equipment; circuitry for, in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and circuitry for sending, at a second time which is after the first time, a second policy control set-up request for the at least one user equipment.

According to a twelfth aspect, there is provided a method performed by an apparatus, the method comprising: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to some examples, the method comprises receiving, in response to the second policy control set-up request, an identifier of a policy and charging function.

According to some examples, the method comprises contacting the policy and charging function to create the at least one policy association for the at least one user equipment, the at least one policy association comprising at least one of the following: a user equipment behaviour policy; an access management policy; or a session management policy.

According to some examples, the method comprises waiting for a configured time period after sending the first policy control set-up request before sending the second policy discovery request.

According to some examples, the method comprises sending a subscription request in response to receiving the error response, and waiting for a notification before sending the second policy control set-up request.

According to some examples, the method comprises sending an error message when it is determined that no suitable policy and charging function is assigned for the at least one user equipment and the at least one user equipment is not registered with a unified data management node.

According to some examples, the first and second policy discovery requests are sent to a binding support function which acts as an intermediary between the apparatus and a unified data management node.

According to some examples, the apparatus comprises a network exposure function node.

According to a thirteenth aspect, there is provided a computer program comprising instructions which, when executed by an apparatus, cause the apparatus to perform at least the following: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to a fourteenth aspect, there is provided a computer program comprising instructions stored thereon for performing at least the following: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to a fifteenth aspect, there is provided a non-transitory computer readable medium comprising program instructions that, when executed by an apparatus, cause the apparatus to perform at least the following: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to a sixteenth aspect, there is provided a non-transitory computer readable medium comprising program instructions stored thereon for performing at least the following: sending, at a first time, a first policy control set-up request for setting up a policy association for at least one user equipment, a purpose of the policy association being to satisfy service requirements of a service which has been or will be provisioned at the at least one user equipment; in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and sending, at a second time which is after the first time, a second policy control set-up request for the at least one user equipment.

According to a seventeenth aspect, there is provided an apparatus comprising: means for subscribing to a unified data management node for information relating to at least one user equipment; means for receiving, from the unified data management node an indication that a flag has been updated at the unified data management node from a first state to a second state, wherein the first state indicates that no policy association is required for at least one user equipment and the second state indicates that a policy association is required for the at least one user equipment; and means for, in response to receiving the indication that the flag has been updated, communicating with a policy control function to establish a policy association for the at least one user equipment.

According to some examples, the apparatus comprises an Access and Mobility Management Function.

According to some examples, the apparatus comprises a Session Management Function.

According to some examples, the means comprises at least one processor; and at least one memory storing instructions that, when executed by the at least one processor, cause the performance of the apparatus.

According to an eighteenth aspect, there is provided an apparatus comprising: at least one processor; and at least one memory storing instructions that, when executed by the at least one processor, cause the apparatus at least to perform: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

According to a nineteenth aspect, there is provided an apparatus comprising: circuitry for subscribing to a unified data management node for information relating to at least one user equipment; circuitry for receiving, from the unified data management node an indication that a flag has been updated at the unified data management node from a first state to a second state, wherein the first state indicates that no policy association is required for at least one user equipment and the second state indicates that a policy association is required for the at least one user equipment; and circuitry for, in response to receiving the indication that the flag has been updated, communicating with a policy control function to establish a policy association for the at least one user equipment

According to a twentieth aspect, there is provided a method performed by an apparatus, the method comprising: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

According to a twenty first aspect, there is provided a computer program comprising instructions which, when executed by an apparatus, cause the apparatus to perform at least the following: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

According to a twenty second aspect, there is provided a computer program comprising instructions stored thereon for performing at least the following: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

According to a twenty third aspect, there is provided a non-transitory computer readable medium comprising program instructions that, when executed by an apparatus, cause the apparatus to perform at least the following: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

According to a twenty fourth aspect, there is provided a non-transitory computer readable medium comprising program instructions stored thereon for performing at least the following: subscribing to a unified data management node for information relating to at least one user equipment; receiving, from the unified data management node an indication that a flag has been updated at the unified data management node from a first state to a second state, wherein the first state indicates that no policy association is required for at least one user equipment and the second state indicates that a policy association is required for the at least one user equipment; and, in response to receiving the indication that the flag has been updated, communicating with a policy control function to establish a policy association for the at least one user equipment.

### BRIEF DESCRIPTION OF DRAWINGS

Some example embodiments will now be described, by way of non-limiting and illustrative example only, with reference to the accompanying figures in which:

FIG. 1 shows a representation of a network system according to some example embodiments;

FIG. 2 is a signalling diagram according to one example embodiment;

FIG. 3 is a signalling diagram according to another example embodiment;

FIG. 4 shows a schematic representation of a control apparatus according to some example embodiments;

FIG. 5 shows a schematic representation of an apparatus according to some example embodiments;

FIG. 6 is a flow chart of a method according to an example embodiment;

FIG. 7 is a flow chart of a method according to an example embodiment;

FIG. 8 is a flow chart of a method according to an example embodiment;

FIG. 9 shows a schematic representation of a non-volatile memory medium storing instructions which when executed by a processor allow a processor to perform one or more of the steps of the methods of some example embodiments.

### DETAILED DESCRIPTION

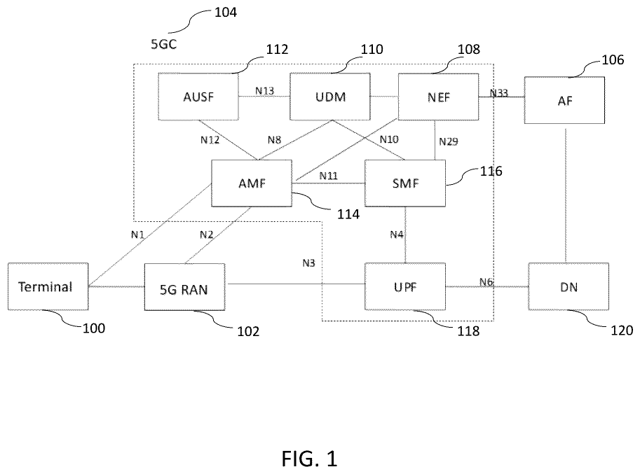

In the following, various example embodiments are explained with reference to mobile communication devices capable of communication via a wireless cellular system and mobile communication systems serving such mobile communication devices. Before explaining the various example embodiments in further detail, certain general facets of a wireless communication system, access systems thereof, and mobile communication devices are briefly explained with reference to FIG. 1 to assist in understanding the technology underlying the described examples.

FIG. 1 shows a schematic representation of a 5G system (5GS), which is provided as a non-limiting and illustrative example of a communication system. The 5GS may comprise a terminal or user equipment (UE) 100, a 5G radio access network (5GRAN) 102 or next generation radio access network (NG-RAN), a 5G core network (5GC) 104, one or more application function (AF) 106 and one or more data networks.

The 5G-RAN may comprise one or more gNodeB (gNB) or one or more gNodeB (gNB) distributed unit functions connected to one or more gNodeB (gNB) centralized unit functions.

The 5GC 104 may comprise the following entities (by way of non-limiting and illustrative example): Network Slice Selection Function (NSSF); Network Exposure Function 108; Network Repository Function (NRF); Policy Control Function (PCF); Unified Data Management (UDM) 110; Application Function (AF) 106; Authentication Server Function (AUSF) 112; an Access and Mobility Management Function (AMF) 114; Session Management Function (SMF) 116; User Plane Function 118; and Data Network (DN) 120. FIG. 1 also shows the various interfaces (N1, N2 etc.) that may be implemented between the various elements of the system.

It is noted that whilst some example embodiments are described in relation to 5G networks, similar principles can be applied in relation to other networks and communication systems, such as 5G-Advanced networks, 6G networks, and beyond.

In the 5GC, different kinds of policies are used. For example, these policies may be provided by the PCF to the AMF, the SMF or the UE. In some examples, the PCF determines the policies, and the PCF would also typically store the policies and deliver the policies. The policies are also stored at the policy receiver side. The policy receiver side could be, for example, a UE (for UE policies), the AMF (for AMF policies), and the SMF (for SMF policies). Three such policies are:
UE (user equipment) policies: provided to a UE via the AMF upon UE registration and determine the behaviour of the UE. For example, these policies may determine behaviour for Access Network Discovery/Selection (ANDSP) and for UE Route Selection (URSP). UE policies may also determine behaviours for V2X, A2X, ProSe settings.
AM (access management) policies: requested by and provided to the AMF upon UE registration. These policies determine access and mobility settings, such as RAT/Frequency Selection (RFSP) and Service Area Restrictions (SAR).
SM (session management) policies: requested by and provided to the SMF upon PDU Session Establishment. These policies determine session management settings, such as authorized QoS, usage limits, charging information, and more.

According to certain 3GPP specifications, all three types of policies may be provided by the PCF to the AMF/SMF only if the AMF/SMF explicitly requests policy control to be applied by the PCF. The policies are requested by establishing a (UE/AM/SM) Policy Association to the PCF.

In one exception, the AMF shall establish a Policy Association if the UE indicates it needs a Policy Association, for example by including a UE policy container. The AMF and the SMF currently determine whether to establish a Policy Association or not based on local configuration.

A proposal in the 3GPP SA2 group implies the addition of three flags (one for each type of policy) in the operator-provisioned UE subscription data in the UDM/UDR. These flags would be retrieved by the AMF/SMF and would indicate to them if a Policy Association shall be established for a UE or for a PDU Session of the UE. These flags are called hereinafter “smPoIEnabled” (i.e., session management policy enabled), “amPoIEnabled” (i.e., access management policy enabled), and “uePoIEnabled” (i.e., UE policy enabled) and are based on the discussion in the 3GPP SA2 WID proposal S2-2306435.

Some AM, UE, and SM Policy Associations may be established and maintained until the UE deregisters or the PDU Session terminates. However, there are no policies for this Subscription Permanent Identifier (SUPI) (and/or DNN and S-NSSAI). Also, the AMF may trigger a request for UE Policies without knowing if the UE needs UE Policies or not. For example, some IoT devices may not need any UE Policies. This may impact performance and increase signalling.

The addition of the flags mentioned above can help an operator provision/configure values that may help the AMF/SMF take better decisions to avoid establishing unnecessary Policy Associations. However, it is not currently known when and how these flags are to be provisioned. Ways of managing and exchanging dynamic information related to the requirement to establish a Policy Association (or not) in the 5GC are also undefined.

This disclosure considers the following use cases (by way of non-limiting and illustrative examples). The disclosure also identifies that these use cases can be dealt with in an efficient manner with some additional information and procedures that complement the proposed flags:
Use Case 1: AF issuing AM influence requests targeting “any UE” based on application usage. An AM Influence request may be considered a request that is intended to influence Access and Mobility policies. In some examples, an AF may provide requirements in terms of throughput and coverage, and the PCF translates the requirements to AM policies (e.g., appropriate RFSP and SAR values).
   The NEF AMInfluence API allows an AF to send requests with throughput requirements and coverage requirements (which are translated by the 5GC to AM policies, e.g., to RFSPs and SARs, respectively). These requests may target any UE that is using a certain application (e.g., the application that is managed/handled by this AF). This activates an application detection mechanism in the 5GC to figure out which UEs would require AM policies due to such a request. This means that the operator normally is not aware for which UEs it should set the “AM policies required” flag in the UDM because it does not know, for example, which UEs will install an app (e.g., Netflix) and when they are going to use it.
Use Case 2: AF issuing Service Parameter Data provisioning requests to provide URSP guidance to support local breakouts (edge computing) for any UE based on application usage.
   This case is similar to Use Case 1 with the difference that it uses the ServiceParameter API of the NEF and it impacts UE Policies (URSPs) instead of AM Policies. The mechanism and the reasons for dynamic changes (e.g., not easily predictable changes) in the requirement to establish Policy Associations for certain UEs are as described above.
Use Case 3: AF issuing a request for certain QoS, targeting a UE IP address.
   The AF can invoke the AfSessionWithQOS API of the NEF to do this, and the target is a UE IP address. An issue is that the trigger for an AF to issue such a request is often the detection of the start or stop of an application running on the UE, which is performed by the AF itself instead of the 5GC as in Use Cases 1 and 2. For similar reasons as before, neither the SUPI nor the IP address can be used by the operator to provision the flag before an AF actually determines that this UE is using its application. Note that in many cases, the AF is not even expected to know the list of UEs that may possibly use this application. It may only know their IP addresses once they have been assigned and the UE has started using the application.
Use Case 4: AF issuing a request to NEF to set a chargeable party for an AF session for a particular UE.

In view of the above, a proposal of the disclosure is the definition or provision of criteria for the determination of the requirement to establish/terminate a (UE, AM, or SM) Policy Association. The disclosure further provides procedures and mechanisms for exchanging and managing information about these criteria in the 5GC. In some examples, these procedures include:
A procedure for the dynamic setting of flags in UE subscription data or in UE policy data of UDR or UDM, for the requirement to establish/terminate UE, AM or SM policy associations.
Those procedures are executed by the PCF, NEF or UDR based on analysis of incoming AF requests and/or the application detection events that trigger the “activation” of such AF requests.
The resetting or automatic expiry of the flags associated with UE, AM and SMF policy associations
In one example, two flags are defined for each of UE, AM or SM policy associations in the subscription data of a UE: One flag is set based on configured operator policy and only applies when the second flag is not set. The second flag is set and may be cleared based on AF requests.
In another example, only one flag is used. If this flag is set to “policy association required” (e.g., due to configured operator policy) and no additional information is stored, AF request does not trigger the start of expiry timers or the storage of AF IDs.
Provisioning of the dynamic criteria/flags to the AMF and SMF via subscription, to new types of Policy Data in the UDR.
Procedures that enable the setting of the flags at the UDM by the NEF when the NEF discovers that no PCF is assigned for a UE, for example by querying the Binding Support Function (BSF).

Where reference is made to a Transaction ID, it will be understood that this may mean an identifier, such as a unique identifier, of a request or session. For example, the request or session may be at least one of the following: an ongoing or current session; or a future session. For example, the Transaction ID may be associated with a request or session between two NFs e.g., an AF/NEF request to the PCF for specific QoS, or a request of the NEF to the UDM to set a flag etc.

According to some example embodiments, UE subscription data types (as defined in Table 5.2.3.3.1-1 of TS 23.503, relating to a particular UE) in the UDM are enhanced as follows.

Access and Mobility Subscription data:

| | |
|---|---|
| amReqInd | Flag that indicates whether an AM policy |
| | association is required |
| amReqExpiry | Contains a time at which the UDM shall |
| | reset “amReqInd” to “false”. It may exist only |
| | while “amReqInd” equals to “true”. May be |
| | stored only internally in the UDM but not be |
| | exposed to UDM service consumers. |
| amTriggeringEntities | Contains a list of transaction IDs of (AF, |
| | NEF, or PCF) requests to the UDM that are |
| | responsible for a current requirement for AM |
| | policies. It may exist only while “amReqInd” |
| | equals to “true”. |
| | When an AM policy association is no |
| | longer required due to the requests of an AF or |
| | PCF, the transaction ID is removed from the list. |
| | When the last transaction ID is being removed |
| | from the list, the UDM sets the “amReqInd” to |
| | false. |
| | In a variant, a separate amReqExpiry |
| | timer is maintained for each transaction ID. The |
| | timer is started by a request that requires an AM |
| | policy association. At the expiry of the timer, the |
| | transaction ID is removed from the list by the |
| | UDM. |
| | May be stored only internally in the UDM |
| | but not be exposed to UDM service consumers. |
| ueReqInd | Flag that indicates whether a UE policy |
| | association is required |
| ueReqExpiry | Contains a time at which the UDM shall |
| | reset “ueReqInd” to “false”. It may exist only |
| | while “ueReqInd” equals to “true”. May be |
| | stored only internally in the UDM but not be |
| | exposed to UDM service consumers. |
| ueTriggeringEntities | Contains a list of transaction IDs of (AF, |
| | NEF, or PCF) requests that are responsible for |
| | a current requirement for a UE policy |
| | association. It may exist only while “ueReqInd” |
| | equals to “true”. |
| | When a UE policy association is no |
| | longer required due to the request related to the |
| | transaction, this transaction id is removed from |
| | the list. When the last transaction id is being |
| | removed from the list, the UDM sets the |
| | “ueReqInd” to false. |
| | In a variant, a separate ueReqExpiry |
| | timer is maintained for transaction IDs. The |
| | timer is started by a request that requires a UE |
| | policy association. At the expiry of the timer, the |
| | transaction ID is removed from the list by the |
| | UDM. |
| | May be stored only internally in the UDM |
| | but not be exposed to UDM service consumers. |

Session Management Subscription data

| | |
|---|---|
| smReqInd | Flag that indicates whether an SM policy |
| | association is required |
| smReqExpiry | Contains a time at which the UDM shall |
| | reset “smReqInd” to “false”. It may exist only |
| | while “smReqInd” equals to “true”. May be |
| | stored only internally in the UDM but not be |
| | exposed to UDM service consumers. |
| smTriggeringEntities | Contains a list of transaction ids of (AF, |
| | NEF, or PCF) requests that are responsible for |
| | a current requirement for SM policies. It may |
| | exist only while “smReqInd” equals to “true”. |
| | When an SM policy association is no |
| | longer required due to these requests then the |
| | related transaction id is removed from the list. |
| | When the last transaction id is being removed |
| | from the list, the UDM sets the “smReqInd” to |
| | false. |
| | In a variant, a separate smReqExpiry |
| | timer is maintained for each transaction id. The |
| | timer is started by a request that requires an SM |
| | policy association. At the expiry of the timer, the |
| | transaction id is removed from the list by the |
| | UDM. |
| | May be stored only internally in the UDM |
| | but not be exposed to UDM service consumers. |

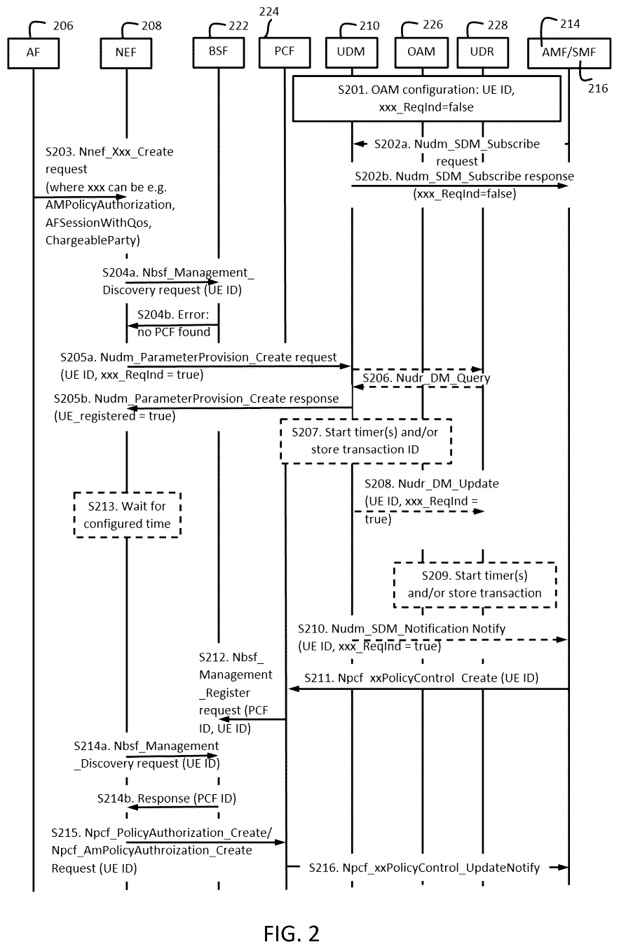

Reference is made to FIG. 2 which is a signalling diagram schematically showing communication between an application function (AF) 206, network exposure function (NEF) 208, binding support function (BSF) 222, policy control function (PCF) 224, unified data management (UDM) 210, operations and maintenance (OAM) 226, unified data repository (UDR) 228, access and mobility management function (AMF) 214 and session management function (SMF) 216.

OAM configuration occurs at S201 between UDM 210, OAM 226 and UDR 228. For example, OAM configuration may be for at least one UE with corresponding at least one UE ID. For example, the UE ID may be a unique identifier of a UE. For example, in 5G the UE ID may be a Subscription Permanent Identifier (SUPI) (internally in the 5GC) or Generic Public Subscription Identifier (GPSI) (externally). OAM configuration may also provide an indication of whether the at least one UE is to be subject to policy control (i.e., whether the at least one UE should have a policy control association set). In some examples, this may be done using the ReqInd flag that indicates whether an AM policy association is required (e.g., amReqInd and/or smReqInd). Where a policy association is required, the flag can be set to TRUE. Where a policy association is not required, the flag can be set to FALSE. In the use case of FIG. 2, the flag is initially set to FALSE at S201. The UDM 210 then stores this flag information. In other words, it may be considered that the UDM 210 stores at least one flag at a first state at a first time, and the flag is associated with at least one user equipment. In the example of FIG. 2, in the first state the flag indicates that no policy association is required for the at least one user equipment (e.g., ReqInd=FALSE).

In some examples, OAM may use business contracts as well as analytics to determine whether a UE will likely require special policies that require an establishment of policy associations. For instance, OAM may use UE Communication analytics provided by the NWDAF. If OAM determines that a UE will likely not require special policies that require the establishment of a policy associations, OAM will set the related xxReqInd flag to false. In some examples, the flag may be in the form of a Boolean indicator which indicates whether a policy association of a specific type (e.g., AM, SM or UE) needs to be established or not. For example, “xx” could be “AM” where an AM policy association needs to be established (amReqInd), “SM” where an SM policy association needs to be established (smReqInd), or “UE” where a UE policy association needs to be established (ueReqInd).

In some examples, when a UE registers to an AMF 214, the AM subscription data is provided by the UDM 210 to the AMF 214. Similarly, when the UE establishes a PDU session, the SMF 216 serving the PDU session of the UE gets the SM subscription data from UDM 210. This is schematically shown at S202a and S202b.

In some examples, if the AM subscription data has the flag amReqInd set to TRUE, the AMF 214 shall establish AM policy association with PCF 224 for the UE.

In some examples, if the AM subscription data has the flag ueReqInd set to TRUE, then the AMF 214 shall establish UE policy association with the PCF 224 for the UE.

In some examples, if the SM subscription data has the flag smReqInd set to TRUE, then the SMF 216 shall establish a SM policy association for the UE session.

At S203, the AF 206 sends a request to NEF 208. For example, the request at S203 may requires an interaction with PCF 224 for one or several UE(s) or a group of Ues indicated in the request, for instance:
1. AF 206 requests to influence access and mobility management policies targeting an individual UE
2. A request for setting up an AF session with required QoS procedure
3. A request for setting a chargeable party
4. Application guidance for URSP determination

Then, as shown at S204a the NEF 208 tries to discover for each UE a PCF assigned to the UE via the BSF 222. This may be referred to as a discovery request. Alternatively, the request at S204a may be referred to as a policy control set-up request. Depending on the nature of the request, the BSF 222 will search for a PCF handling a UE (for examples 1 and 4 in the list above)) or handling a PDU session (for examples 2 and 3 in the list above). If no SM policy association is established for a UE, no PCF handling a PDU session will be assigned. If no UE policy association and/or no AM policy association is established for a UE, no PCF handling a UE will be assigned.

In the example of FIG. 2, at S204b the NEF 208 is informed by the BSF 222 that no suitable PCF is assigned for the one or more Ues. This may be communicated by way of an error message (e.g., Error: no PCF found). In an alternative example, the NEF 208 subscribes to the BSF 222 instead of sending a Discovery request. In the subscription case, there is no error response and the NEF 208 waits for a notification, which would be received later via a Nbsf_Management_Notify (instead of the new discovery request sent by the NEF in S214a), as soon as the PCF performs step S212. In the subscribe case, the configured time shown at S213 (described further below) is not for re-sending a discovery but for cancelling the subscription and (normally) reverting to interaction with the UDM 210.

In some examples, NEF 208 may receive a request from AF 206 that requires an interaction with UDR 228 for the provisioning of policy related information for one or more Ues or a group of Ues indicated in the request. This is shown for example in S205a to S206. For example, AF may request at least one of the following:
AF requests to influence access and mobility management policies (see TS 23.502, Clause 4.15.6.9.3);
AF requests service specific parameter provisioning (see TS 23.502, Clause 4.15.6.7); or
AF requests application guidance for URSP determination (see TS 23.502, Clause 4.15.6.10).

At S205a, the NEF 208 requests the UDM 210 to set the flag requiring the establishment of a suitable policy association (e.g., the “amReqInd” flag of the above Tables to establish a AM policy association, the “ueReqInd” flag of the above Tables to establish a UE policy association, and the “smReqInd” flag of the above Tables to establish an SM policy association). In other words, the flag(s) set to “false” during OAM configuration can be updated to “true”. In some examples, this can be done using the Nudm_ParameterProvision_Create service operation, where the UDM 210 assigns a Transaction Reference ID to the request. In other words, it may be considered that at a second time (which is after the flag was initially set to FALSE during OAM configuration) the UDM receives a request indicating that the flag should be updated to a second state. The second state indicates that a policy association is required for the at least one user equipment.

It is to be noted that, in some examples, there can be more than one entity (e.g., different Afs) that may request to set the flags (amReqInd, ueReqInd, smReqInd). In some examples, a parameter, such as “amTriggeringEntities”, is proposed to store the list of entities (e.g., different AFs) that have requested to set or update the flags. Therefore, it may be considered that “Transaction ID” here refers to transaction id of the different requests to UDM 210.

In some examples, both the “triggering entities” and the “transaction ids (of those triggering entities)” are contained within the “xxTriggeringEnitites” parameters. For example, these parameters could take a form such as: [AF1: tid1, tid2], [AF2: tid3], [PCF: tid4, tid5]}.

At S205b, the UDM responds to the NEF 208, for example confirming that the flag has been set to TRUE.

In examples where UDR interaction is required, there is a step S206 between S205a and S205b, where the UDM 210 queries the UDR 228 for information (for example, registry information) necessary to provide a response to NEF 208.

Thus, the UDM 210 has updated the flag in its internal memory (to TRUE), so that the flag now indicates that a policy association is required or is enabled for a UE or group of UEs associated with the request from S203.

In some examples, where the flag is set to TRUE in response to an AF/NEF request, then, in some examples, the flag is set to TRUE for a pre-determined time before reverting to FALSE or being cleared. To this end, the UDM may implement a timer, upon expiry of which the flag reverts to FALSE or is cleared. In some examples, a transaction ID pertaining to the request may be associated with the timer. Thus, in some examples there may be multiple timers running at the UDM which pertain to different requests, each of which are identifiable by the associated transaction ID. Starting of the timer and storing of associated transaction ID is schematically shown at S207.

In one example, for each type (e.g., AM, SM or UE) of policy association (xxReqInd), the UDM 210 stores both a flag that can be set based on OAM request (which may be referred to as a first flag) and a flag that can be set based on requests of other NFs such as the NEF 208 (which may be referred to as a second flag). For example, for an AM Policy Association establishment requirement the UDM may maintain an “amReqInd_NF” flag (which can be toggled based on AF/NEF/PCF requests) and an “amReqInd_OAM” flag (which can be toggled via OAM, e.g., by the operator itself).

In one example, the UDM 210 may expose only a single flag to service consumers (e.g., AMF 214 or SMF 216), which is set if one or both of the flags (e.g., the flags “amReqInd_NF” and “amReqInd_OAM”) is set. For the purpose of explanation, this single flag could be thought of as a “third” flag (to differentiate from the first and second flags described above). This third flag may be the only flag sent or exposed to the AMF/SMF, and this third flag is set (e.g., based on implementation specific UDM logic) based on the values of the two other flags (e.g., first flag based on OAM input and second flag based on NEF input). In some examples, in practice the UDM logic may set a value of the third flag to a value of one of the first or second flags.

In another example, the UDM 210 may expose both flags to service consumers (e.g., AMF 214 or SMF 216), and the service consumer establishes a related policy association if any of the flags is set to “true”. For backward compatibility reasons, the service consumer may decide whether to establish a policy association based on local configuration when it does not receive any flag.

In another example, the UDM 210 stores a single flag, but uses procedures (described in more detail below) so that the flag remains permanently set upon OAM request, but is only temporarily set upon request of other NFs (e.g., NEF 208), for example using a timer. The indication about who sets the flag to its “current” value may be part of the internal logic of the UDM and not part of the Subscription data, e.g., it is not exposed. This UDM-internal information may be used by the UDM 210 to determine how to set or unset the flag upon new events that toggle or try to toggle the flag:
In one example, if the OAM system 226 sets the flag, the UDM 210 stores an indication that the flag was set by the OAM system and maintains the flag set based on that indication.
In another example, if the flag was not previously set, and an NF other than OAM requests the flag to be set, the UDM 210 stores some additional information (e.g., expiry timer and/or transaction reference IDs as outlined previously and further below). If the flag is set by the OAM system 226 while additional information is stored, the UDM 210 removes the additional information. The UDM 210 can use that additional information to determine when to clear the flag and thus may not clear the flag if no additional information is stored.

In one example, if the flag was previously not set in the UDM 210 the UDM 210 starts a timer. Here (and elsewhere), when a flag is “set” it is meant that the status of the flag is set to true. Upon expiry of the timer, the UDM clears the flag (e.g., sets the flag to false). If the flag was already set (e.g., the flag was already set to true) and a timer is running, the UDM restarts the timer. If the flag is set by the OAM system while the timer is running, the UDM 210 removes the timer. For example, a “amReqExpiry” timer may be used for unsetting a flag which is requested to be set by an AF/NF earlier. In some examples, this may be a single timer maintained internally by the UDM 210, which is overwritten by the UDM 210 for each request.

In one example, the UDM 210 stores a transaction reference ID assigned to the Nudm_ParameterProvision_Create service operation where the setting of the flag has been requested (see “amTriggeringEntities”, “smTriggeringEntities”, and “ueTriggeringEntities” in the data model). The setting of the flag can be requested by several independent transactions, and all related transaction IDs are then stored at the UDM. In examples, each transaction can be terminated independently upon NEF request and the stored related transaction ID is then removed. If the last stored transaction reference ID is removed, the flag is cleared. Each transaction reference ID can also be associated by a timer that is set upon receipt of the corresponding Nudm_ParameterProvision_Create service operation. Upon expiry of the timer, the stored transaction reference ID is also removed.

In a practical example (for the purpose of explanation), if a first AF (AF1) had set the flag to “true” at noon with an expiry at 24 hours, and then a second AF (AF2) sets the flag to “true” again at midnight with an expiry at 24 hours, then the UDM shall restart the timer so that the value “true” stays there until next midnight (and is not removed earlier based on the timer of AF1). This applies for an example where there is a single timer for all transaction ids within the xxTriggeringEntities attribute. In another example, where each transaction has its own timer, the UDM adds and removes transaction ids based on their own timer and then sets the flag back to false only when the xxTriggeringEntities attribute becomes empty again.

In some examples, the timer can be a relative value or an absolute time value provisioned by the AF/NEF/PCF. Each transaction id may be provisioned with its own timer instance, as described above.

In some examples, the UDM 210 may use a UDR 228 as a backend database to store the information (S208 in FIG. 2), query the UDR for authorizing the request, and forward data for storage to the UDR. The data may include the xxReqInd indication and AF transaction identifiers, as shown at S210. In a variant, the timers described above are located in the UDR 228 rather than in the UDM 210 (e.g., S209 may take place instead of S207).

In a variant, the UDM 210 indicates in the response to the request for setting the flag(s) to the NEF 208 whether the UE is currently registered.

In examples, the AMF 214 may subscribe at the UDM 210 to changes of Access and Mobility Subscription data when a UE registers. Thus, AMF 214 is informed by the UDM 210 when the flag that indicates whether an AM policy association is required is set or cleared. This is shown at S210 in FIG. 2. Similarly, AMF 214 is informed by UDM 210 when the flag that indicates whether a UE policy association is required is set or cleared (this may additionally or alternatively occur at S210). The AMF 214 establishes or terminates a corresponding policy association. This enables a PCF (e.g., PCF 224) handling a UE to be selected and to be registered at the BSF 222. For backward compatibility reasons, in some examples, the AMF 214 will decide whether to establish a UE policy association and/or a AM policy association based on local configuration when it does not receive any flag.

In some examples, when the AMF 214 serving a UE registration registers to the UDM 210, the AMF 214 can get the AM Subscription data from UDM 210. The AM subscription data may also include the new information (e.g., flag status information). As explained above, the AMF 214 can subscribe to get notified when any AM subscription data changes. For example, UDM 210 notifies the AMF 214 when the data changes (e.g., the flag changes from TRUE to FALSE). When the flag is TRUE, the AMF 214 will establish AM or UE policy association.

According to some examples, an SMF 216 may subscribe at the UDM 210 to changes of Session Management Subscription data when a PDU session is established. Thus, SMF 216 can be informed by the UDM 210 when the flag that indicates whether an SM policy association is required is set or cleared (again, this could be at S210 in FIG. 2, for example). SMF 216 then establishes or terminates a corresponding policy association, meaning that a PCF (e.g., PCF 224) handling a PDU session can be selected and registered at the BSF 222. For backward compatibility reasons, in some examples, the SMF 216 can decide whether to establish an SM policy association based on local configuration when it does not receive any flag.

In some examples, when the SMF 216 serving a UE's PDU session registers to the UDM 210, the SMF 216 can get the SM Subscription data from UDM 210. The SM subscription data may also include the new information (e.g., flag status information). As explained above, the SMF 216 can also subscribe to get notified when any SM subscription data changes. For example, the UDM 210 notifies the SMF 216 when the data changes e.g., the flag changes from TRUE to FALSE. When the flag is TRUE the SMF 216 will establish SM association.

S211 schematically shows a created policy association for an UE ID being sent from AMF 214 and/or SMF 216 to PCF 224, which information is then forwarded to BSF 222 at S212.

In some examples, if the NEF 208 is informed by the BSF 222 that no suitable PCF 224 is assigned for the UE (and, in some examples if in addition the NEF 208 is informed by the UDM 210 that the UE is currently registered), the NEF 208 waits for a grace period after contacting the UDM 210. For example, after sending the request at S205a, the NEF 208 may wait for the grace period. In FIG. 2, waiting for the grace period is schematically shown at S213. For example, the NEF 208 may use a timer for the purpose of implementing the grace period. After the grace period has expired then NEF 208 can try again to discover a PCF via the BSF. As outlined above, a policy association will in the meantime have been established and a PCF 224 will have registered at the BSF 222 (e.g., at S212). The NEF 208 may then interact with the PCF 224 as required by existing procedures.

As an alternative to implementation of the timer at the NEF 208 (e.g., as an alternative to S213), if the NEF 208 is informed by the BSF 222 that no suitable PCF is assigned for the UE e.g., at S204b (and in an example, if additionally the NEF 208 is informed by the UDM 210 that the UE is currently registered), the NEF 208 may subscribe to the BSF 222 to be notified when a PCF serving UE/AM/SM policy association for the UE registers to the BSF 222 (e.g., the PCF with which the XX Policy Association has been established by the AMF or the SMF, or stated differently the PCF that was selected by the AMF or SMF and now handles/determines the respective policies). As outlined above, a policy association may in the meantime have been established and a PCF 224 may have registered at the BSF 222. The BSF 222 would then notify the NEF 208 about the PCF 224 that has been registered. The NEF 208 may then interact with the PCF 224 as required, for example according to existing procedures.

In another example, if the NEF 208 is informed by the BSF 222 that no suitable PCF is assigned for the UE and if in addition the NEF 208 is informed by the UDM 210 (e.g., at S205b in the below figure) that the UE is currently not registered (e.g., UE_registered=FALSE), the NEF 208 may reply to a request from an AF 206 that requires an interaction with a PCF with an error response that the requested configuration is not possible for the UE.

After the configured time period set at S213 has expired (or after NEF 208 learns via subscription notification that a PCF has been registered), as shown at S214a the NEF may re-attempt the PCF discovery (or policy control set-up) request, as shown at S214a. For example, it may be considered that S214a is a re-attempt of the discovery request sent at S204a.

Then, at S214b (and in contrast to S204b), the NEF 208 receives from BSF 222 a response which includes PCF ID. This enables the NEF 208 to then contact the relevant PCF (e.g., PCF with the PCF ID) to get policy information (e.g., UE policy information, AM policy information, SM policy information) for the one or more UEs (e.g., UEs with the UE IDs from OAM configuration at S201).

The NEF 208 may then directly contact the PCF 224. For example, the NEF 208 can provide inputs to the PCF 224 that can influence the policies. In some APIs, the NEF 208 provides the content or substantially the content of the desired policy (though usually not entirely). In other APIs, the NEF 208 just sends a couple of requirements letting the PCF determine policies accordingly. In other words, it may be considered that in examples the NEF 208 does not know the 5G policies and has no access to them, but the NEF can send requests to influence the policies.

This is schematically shown at S215.

The PCF 224 may also send an update to AMF 214 and/or SMF 216 informing that the policy associations have been made at the PCF 224. This is schematically shown at S216.

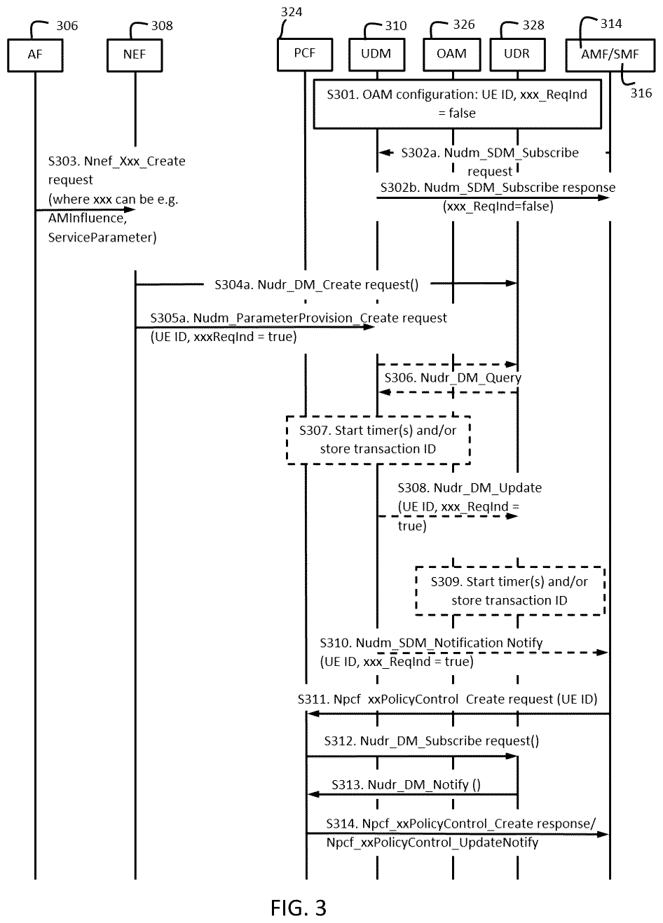

Reference is now made to FIG. 3 which shows an example where the BSF is not present. Thus, FIG. 3 schematically shows communication between AF 306, NEF 308, PCF 324, UDM 310, OAM 326, UDR 328, AMF 314 and SMF 316. Many of the steps in FIG. 3 are analogous to those of FIG. 2, and therefore the detailed description of such steps provided with respect to FIG. 2 are equally applicable to FIG. 3.

One difference is that, due to the omission of BSF, in response to create request at S303 a PCF discovery (or policy control set-up) request is not sent to BSF. Instead, a create request is sent directly from NEF 308 to UDR 328, as schematically shown at S304. For example, this request may be an Nudr_DM_Create request.

From the foregoing it can be seen that the disclosure introduces, inter alia, some new information elements in the AM subscription data and SM subscription data in UDM. Based on the value of flag(s) in the new information elements stored in the UDM (which is provided by the UDM to the AMF or SMF), the AMF can decide whether to perform an AM/UE policy association establishment with PCF, and the SMF can decide whether to perform SM policy association with the PCF.

The present disclosure thus introduces more dynamic behaviour, compared to current behaviour which is that based on local configuration and operator policy the AMF decides whether to perform AM policy association establishment.

In some examples, the AMF may not establish any AM/UE policy association with the PCF initially (e.g., if flag status is false). When there is an AF request to influence some AM policies or UE policies and the network determines that there is no PCF serving a UE, the network (e.g., NEF) may cause an update of the newly introduced flags in the AM subscription data in UDM. When these flags are updated, the AMF gets a notification and then establishes a policy association with the PCF.

The policy association may only be required for a period of time, and hence according to some examples logic is introduced in UDM (e.g., a timer) which enables the UDM to clear the flag after some time.

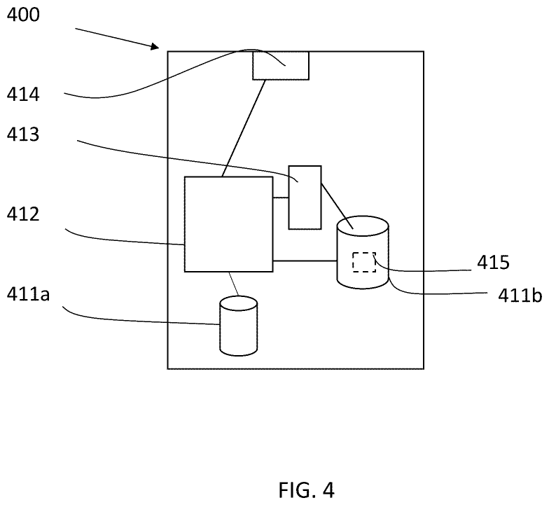

FIG. 4 illustrates an example of a control apparatus 400 for controlling a function of the 5GRAN or the 5GC as illustrated on FIG. 1. The control apparatus may comprise at least one random access memory (RAM) 411a, at least on read only memory (ROM) 411b, at least one processor 412, 413 and an input/output interface 414. The at least one processor 412, 413 may be coupled to the RAM 411a and the ROM 411b. The at least one processor 412, 413 may be configured to execute an appropriate software code 415. The software code 415 may for example allow to perform one or more steps to perform one or more of the present aspects. The software code 415 may be stored in the ROM 411b. The control apparatus 400 may be interconnected with another control apparatus 400 controlling another function of the 5GRAN or the 5GC. In some example embodiments, each function of the 5GRAN or the 5GC comprises a control apparatus 400. In alternative example embodiments, two or more functions of the 5GRAN or the 5GC may share a control apparatus. By way of non-limiting and illustrative example, functions, such as, at least one of AF; NEF; PCF; UDM; OAM; UDR; AMF; or SMF may be controlled by an apparatus of the type as shown in FIG. 4. In some examples, the apparatus may be configured to operate at least one of the following functions: AF; NEF; PCF; UDM; AMF; or SMR.

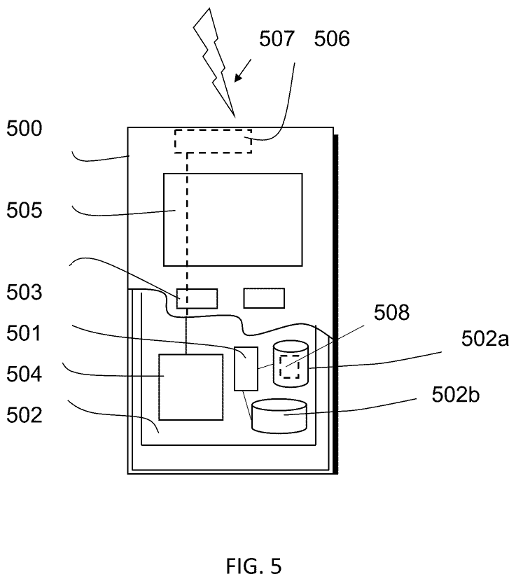

FIG. 5 illustrates an example of a terminal 500, such as the terminal 100 illustrated on FIG. 1. The terminal 500 may be provided by any device capable of sending and receiving radio signals. Non-limiting and illustrative examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 500 may provide, for example, communication of data for carrying communications. The communications may be one or more of voice, electronic mail (email), text message, multimedia, data, machine data and so on.

The terminal 500 may be provided with at least one processor 501, at least one memory ROM 502a, at least one RAM 502b and other possible components 503 for use in software and hardware aided execution of tasks it is designed to perform, including control of access to and communications with access systems and other communication devices. The at least one processor 501 is coupled to the RAM 502b and the ROM 502a. The at least one processor 501 may be configured to execute an appropriate software code 508. The software code 508 may for example allow to perform one or more of the present aspects. The software code 508 may be stored in the ROM 502a.

The processor, storage and other relevant control apparatus can be provided on an appropriate circuit board and/or in chipsets. This feature is denoted by reference 504. The device may optionally have a user interface such as key pad 505, touch sensitive screen or pad, combinations thereof or the like. Optionally, at least one of the following a display, a speaker or a microphone, may be provided depending on the type of the device.

The terminal 500 may receive signals over an air or radio interface 507 via appropriate apparatus for receiving and may transmit signals via appropriate apparatus for transmitting radio signals. In FIG. 5 transceiver apparatus is designated schematically by block 506. The transceiver apparatus 506 may be provided for example by means of a radio part and associated antenna arrangement. The antenna arrangement may be arranged internally or externally to the mobile device.

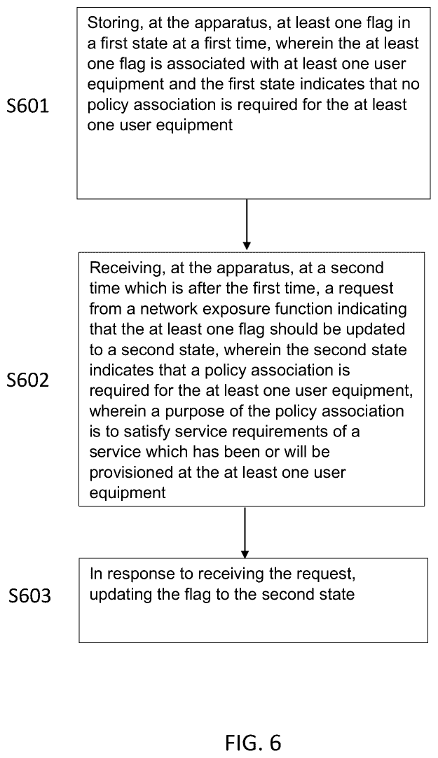

FIG. 6 is a flow chart of a method according to an example embodiment. The flow chart of FIG. 6 may be viewed from the perspective of an apparatus. For example, the apparatus may comprise or may host a Unified Data Management (UDM) node. In some examples, the apparatus may be configured to operate as a UDM node. For instance, the apparatus may be configured to perform one or more functions of a UDM.

As shown at S601 the method comprises storing, at the apparatus, at least one flag in a first state at a first time, wherein the at least one flag is associated with at least one user equipment and the first state indicates that no policy association is required for the at least one user equipment.

As shown at S602 the method comprises receiving, at the apparatus, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment.

As shown at S603 the method comprises, in response to receiving the request, updating the flag to the second state.

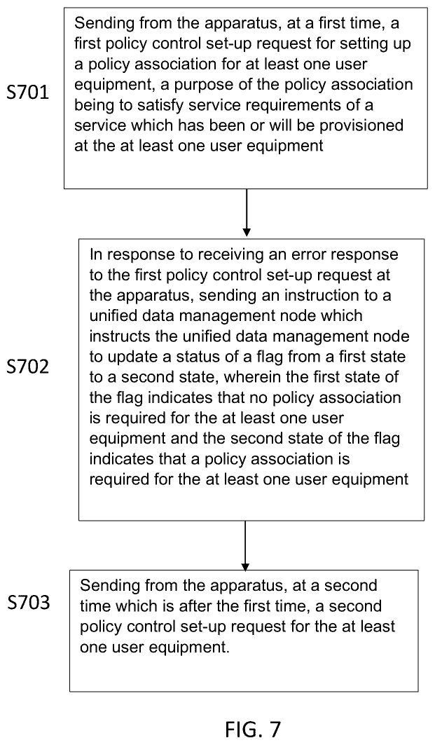

FIG. 7 is a flow chart of a method according to an example embodiment. The flow chart of FIG. 7 may be viewed from the perspective of an apparatus. For example, the apparatus may comprise or may host a Network Exposure Function (NEF) node. In some examples, the apparatus may be configured to operate as an NEF node. For instance, the apparatus may be configured to perform one or more functions of an NEF.

As shown at S701 the method comprises sending from the apparatus, at a first time, a first policy control set-up request for setting up a policy association for at least one user equipment, a purpose of the policy association being to satisfy service requirements of a service which has been or will be provisioned at the at least one user equipment.

As shown at S702 the method comprises in response to receiving an error response to the first policy control set-up request at the apparatus, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment.

As shown at S703 the method comprises sending from the apparatus, at a second time which is after the first time, a second policy control set-up request for the at least one user equipment.

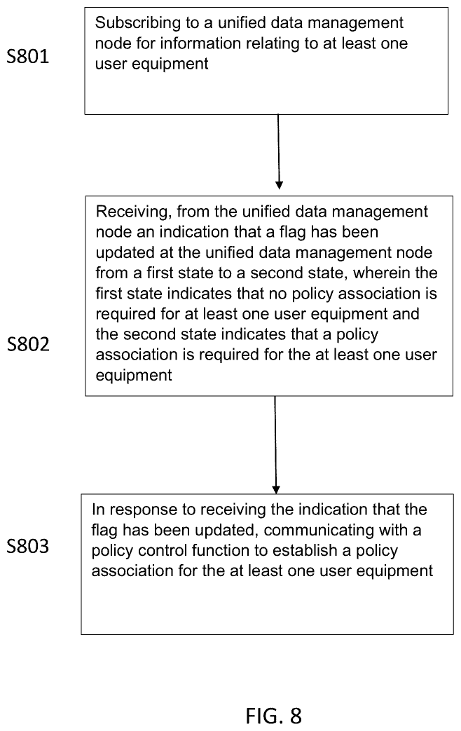

FIG. 8 is a flow chart of a method according to an example embodiment. The flow chart of FIG. 8 may be viewed from the perspective of an apparatus. For example, the apparatus may comprise or may host an AMF or an SMF. In some examples, the apparatus may be configured to operate as an AMF node and/or an SMF. For instance, the apparatus may be configured to perform one or more functions an AMF and/or an SMF.

As shown at S801 the method comprises subscribing to a unified data management node for information relating to at least one user equipment.

As shown at S802 the method comprises receiving, from the unified data management node an indication that a flag has been updated at the unified data management node from a first state to a second state, wherein the first state indicates that no policy association is required for at least one user equipment and the second state indicates that a policy association is required for the at least one user equipment.

As shown at S803 the method comprises, in response to receiving the indication that the flag has been updated, communicating with a policy control function to establish a policy association for the at least one user equipment.

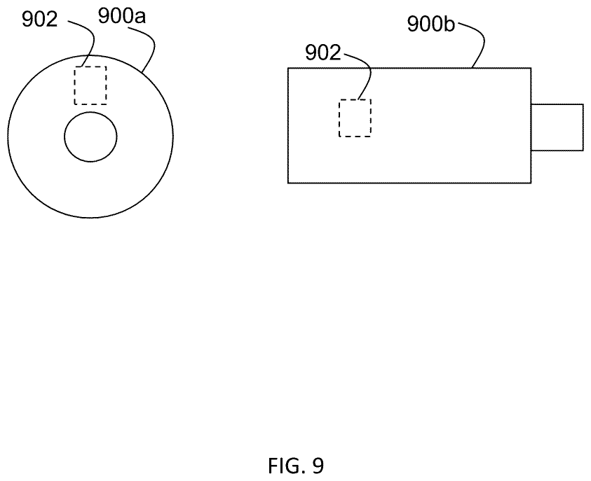

FIG. 9 shows a schematic representation of non-volatile memory media 900a (e.g., computer disc (CD) or digital versatile disc (DVD)) and 900b (e.g., universal serial bus (USB) memory stick) storing instructions and/or parameters 902 which when executed by a processor allow the processor to perform one or more of the steps of the method of any of FIGS. 6 to 8.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some example embodiments have been described in relation to 5G networks, similar principles can be applied in relation to other networks and communication systems (e.g., 6G networks, and beyond). Therefore, although certain example embodiments were described above, by way of non-limiting and illustrative example, with reference to certain example architectures for wireless networks, technologies and standards, example embodiments may be applied to any other suitable forms of communication systems than those illustrated and described herein.

It is also noted herein that while the above describes example embodiments, there are several variations and modifications which may be made to the disclosed solution without departing from the scope of the present invention.

It shall be understood that although the terms “first,” “second” and the like may be used herein to describe various elements, these elements should not be limited by these terms. These terms are only used to distinguish one element from another. For example, a first element

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the term “and/or” includes any and all combinations of one or more of the listed terms.

As used herein, unless stated explicitly, performing a step “in response to A” does not indicate that the step is performed immediately after “A” occurs and one or more intervening steps may be included.

In general, the various example embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used herein, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The various example embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out example embodiments. The one or more computer-executable components may be at least one software code or portions of it.

Further in this regard, it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media, such as hard disk or floppy disks, and optical media such as for example DVD and the data variants thereof, CD. The physical media may be a non-transitory media.

The term “non-transitory,” as used herein, is a limitation of the medium itself (e.g., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Various example embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the disclosure is set out by the independent claims. The example embodiments and features thereof, if any, described in this disclosure that do not fall under the scope of the independent claims are to be interpreted as examples useful for understanding various example embodiments of the disclosure.

The foregoing description has provided, by way of non-limiting and illustrative examples, a full and informative description of the various example embodiments of this disclosure. However, various modifications and adaptations may become apparent to those skilled in the relevant arts in view of the foregoing description, when read in conjunction with the accompanying drawings and the claims. However, all such and similar modifications of the teachings will still fall within the scope of various example embodiments of the disclosure as set forth in the claims. By way of non-limiting and illustrative example, there is a further example embodiment comprising a combination of one or more example embodiments with any of the other example embodiments previously discussed.

A non-exhaustive list of acronyms used herein is provided below:
5GC—5G core
BSF—binding support function
AMF—Access and Mobility Management Function
NEF—Network Exposure Function
NF—Network Function
NWDAF—Network Data Analytics Function
PCF—Policy Control Function
RFSP—RAT/Frequency Selection Policy
SAR—Service Area Restrictions
SMF—Session Management Function
UDR—Unified Data Repository
UE—User Equipment
URSP—UE Route Selection Policies

1. An apparatus comprising at least one processor; and at least one memory storing instructions that, when executed by the at least one processor, cause the apparatus at least to perform:
storing at least one flag in a first state at a first time, wherein the at least one flag is associated with at least one user equipment and the first state indicates that no policy association is required for the at least one user equipment;
receiving, at a second time which is after the first time, a request from a network exposure function indicating that the at least one flag should be updated to a second state, wherein the second state indicates that a policy association is required for the at least one user equipment, wherein a purpose of the policy association is to satisfy service requirements of a service which has been or will be provisioned at the at least one user equipment; and
in response to receiving the request, updating the flag to the second state.

2. An apparatus according to claim 1, wherein the instructions, when executed by the at least one processor, cause the apparatus at least to perform: storing a transaction identifier which is specific to the request.

3. An apparatus according to claim 2, wherein the instructions, when executed by the at least one processor, cause the apparatus at least to perform: receiving multiple requests and multiple corresponding transaction identifiers.

4. An apparatus according to claim 1, wherein the instructions, when executed by the at least one processor, cause the apparatus at least to perform: starting a timer in response to updating the flag to the second state, and reverting the flag to the first state upon expiry of the timer.

5. An apparatus according to claim 1, wherein the instructions, when executed by the at least one processor, cause the apparatus at least to perform: causing one or more other entities to update the flag to the second state, the one or more other entities comprising at least one of the following: a Unified Data Repository; or an Access and Mobility Management Function.

6. An apparatus according to claim 1, wherein the policy association comprises at least one of the following: a user equipment behaviour policy; an access management policy; or a session management policy.

7. An apparatus according to claim 1, wherein the service which has been or will be provisioned at the at least one user equipment is provisioned by an application function.

8. An apparatus according to claim 1, wherein the at least one flag comprises a first flag, and the instructions, when executed by the at least one processor, cause the apparatus at least to perform: storing a second flag, wherein the second flag is configured to be updated between the first state and the second state in response to an instruction from an operation and maintenance node.

9. An apparatus according to claim 8, wherein the instructions, when executed by the at least one processor, cause the apparatus at least to perform: exposing both the first and second flags to a service consumer; or exposing only one of the first or second flags to a service consumer.

10. An apparatus according to claim 1, wherein the apparatus comprises a unified data management node.

11. An apparatus comprising at least one processor; and at least one memory storing instructions that, when executed by the at least one processor, cause the apparatus at least to perform:
sending, at a first time, a first policy control set-up request for setting up a policy association for at least one user equipment, a purpose of the policy association being to satisfy service requirements of a service which has been or will be provisioned at the at least one user equipment;
in response to receiving an error response to the first policy control set-up request, sending an instruction to a unified data management node which instructs the unified data management node to update a status of a flag from a first state to a second state, wherein the first state of the flag indicates that no policy association is required for the at least one user equipment and the second state of the flag indicates that a policy association is required for the at least one user equipment; and
sending, at a second time which is after the first time, a second policy control set-up request for the at least one user equipment.

12. An apparatus according to claim 11, wherein the instructions, when executed by the at least one processor, cause the apparatus at least to perform: receiving, in response to the second policy control set-up request, an identifier of a policy and charging function.

13. An apparatus according to claim 12, wherein the instructions, when executed by the at least one processor, cause the apparatus at least to perform: contacting the policy and charging function to create the at least one policy association for the at least one user equipment, the at least one policy association comprising at least one of the following: a user equipment behaviour policy; an access management policy; or a session management policy.

14. An apparatus according to claim 11, wherein the instructions, when executed by the at least one processor, cause the apparatus at least to perform: waiting for a configured time period after sending the first policy control set-up request before sending the second policy discovery request.

15. An apparatus according to claim 11, wherein the instructions, when executed by the at least one processor, cause the apparatus at least to perform: sending a subscription request in response to receiving the error response, and waiting for a notification before sending the second policy control set-up request.

16. An apparatus according to claim 11, wherein the instructions, when executed by the at least one processor, cause the apparatus at least to perform: sending an error message when it is determined that no suitable policy and charging function is assigned for the at least one user equipment and the at least one user equipment is not registered with a unified data management node.

17. An apparatus according to claim 11, wherein the first and second policy discovery requests are sent to a binding support function which acts as an intermediary between the apparatus and a unified data management node.

18. An apparatus according to claim 11, wherein the apparatus comprises a network exposure function node.

19. An apparatus comprising at least one processor; and at least one memory storing instructions that, when executed by the at least one processor, cause the apparatus at least to perform:
subscribing to a unified data management node for information relating to at least one user equipment;
receiving, from the unified data management node an indication that a flag has been updated at the unified data management node from a first state to a second state, wherein the first state indicates that no policy association is required for at least one user equipment and the second state indicates that a policy association is required for the at least one user equipment; and
in response to receiving the indication that the flag has been updated, communicating with a policy control function to establish a policy association for the at least one user equipment.
